(19) United States
(12) Patent Application Publication
(10) Pub. No.: US 2025/0366384 A1
(43) Pub. Date: Dec. 4, 2025

(54) STUBBLE BURYING, PUDDLING, AND LAND LEVELING COMBINED OPERATION MACHINE AND OPERATION METHOD THEREOF

(71) Applicant: Nanjing Agricultural University, Nanjing (CN)

(72) Inventors: Ruiyin HE, Nanjing (CN); Yu Xiong, Nanjing (CN); Yanfeng Ding, Nanjing (CN); Guangzhao Tian, Nanjing (CN); Jun Zhou, Nanjing (CN); Weiguo Meng, Nanjing (CN); Gaoming Xu, Nanjing (CN); Ganhua Li, Nanjing (CN); Zhenghui Liu, Nanjing (CN); Qishuo Ding, Nanjing (CN)

(21) Appl. No.: 19/027,360

(22) Filed: Jan. 17, 2025

(30) Foreign Application Priority Data
May 30, 2024 (CN) 202410686114.X

(51) Int. Cl. A01B 49/02; A01B 63/00; A01B 79/00

(52) U.S. Cl. CPC A01B 49/027; A01B 63/008; A01B 79/005

(57) ABSTRACT

The present disclosure provides a stubble burying, puddling, and land leveling combined operation machine and an operation method thereof. The operation machine includes a main assembly and an operation assembly. The main assembly includes a base rack, auxiliary racks arranged on the base rack, and rear connectors arranged at a back end of the base rack. A leveling component is arranged on the rear connectors. The operation assembly includes a puddling component and a stubble-burying component both arranged on the base rack. During working, an operator unfolds the auxiliary racks through flippers and uses a tractor to lower the entire operation machine to the ground. The operation machine is pulled by the tractor to move and carry out combined operations of stubble burying, puddling, and land leveling.

### CROSS-REFERENCE TO RELATED APPLICATION

This application claims the priority benefit of China application serial no. 202410686114.X, filed on May 30, 2024. The entirety of China application serial no. 202410686114.X is hereby incorporated by reference herein and made a part of this specification.

### TECHNICAL FIELD

The present disclosure relates to the technical field of land leveling combined operation machines, and in particular, to a stubble burying, puddling, and land leveling combined operation machine and an operation method thereof.

### BACKGROUND

Stubble burying, puddling, and land leveling operations are critical to rice planting and directly influence the quality of rice planting and the efficiency of water, fertilizer, and pesticide utilization. The enrichment of straw on the land surface can easily cause problems such as non-point source pollution. Due to the uneven hard bottom layer of the paddy field, the tractor tilts with the terrain during operation. The paddy puddler and land leveler are connected to the tractor by rigid suspension and will swing with the terrain, which seriously affects the quality of paddy field leveling and makes it difficult to meet agronomic requirements.

Existing agricultural machinery and equipment: Since the tractor travels on uneven ground while working, the moving posture of the machine will change with the tractor, which affects the puddling and leveling effect. Most of the existing land levelers use laser and navigation positioning technologies for position monitoring and posture adjustment feedback to achieve the leveling effect. The sensor detects and feeds back the posture of the tractor or tillage machine for the control of the land leveler. The posture of the rear leveling plate is mainly adjusted by a hydraulic-link mechanism based on the feedback. For example, U.S. Pat. No. 20,211,0644856.2 and No. 201910248405.X both disclose the above-mentioned method of adjusting a leveling plate through a link mechanism. However, this method only takes effect after the posture of the traction machine in front changes, so that the information feedback can hardly synchronize with the posture control of the land leveler. Besides, the control mechanism limits multiple degrees of freedom of the land leveler and adaptive adjustment cannot be performed based on soil conditions.

### SUMMARY

The purpose of this section is to summarize some aspects of the present disclosure and briefly introduce some preferred embodiments. Simplifications or omissions may be made in this section and in the abstract and the title of this application to avoid blurring the purposes of this section, the abstract, and the title of the invention, and such simplifications or omissions shall not limit the scope of the present disclosure.

The present disclosure is provided to solve the above problems in the existing stubble burying, puddling, and land leveling combined operation machine.

Therefore, the present disclosure provides a stubble burying, puddling, and land leveling combined operation machine.

To solve the above technical problems, the present disclosure provides the following technical solutions: A stubble burying, puddling, and land leveling combined operation machine includes a main assembly. The main assembly includes a base rack, auxiliary racks arranged on the base rack, and rear connectors arranged at a back end of the base rack. A leveling component is arranged on the rear connectors. The rear connector includes a leveling connection rack arranged at the back end of the base rack and a support rack arranged on the leveling connection rack. The leveling connection rack is connected to the base rack via at least two traction ropes, the traction ropes are configured for driving the leveling component to move forward and backward relative to the base rack, and when the traction ropes retract to a position relative to the base rack, the leveling component is in a suspended state above ground.

In a preferred solution of the stubble burying, puddling, and land leveling combined operation machine according to the present disclosure, the leveling component includes a leveling plate arranged at back ends of the leveling connection racks, joint blocks arranged on the leveling plate, and stoppers respectively arranged on the joint blocks, where a traction component is arranged between the leveling plate and the leveling connection rack.

An adapter plate matching with the stopper is arranged on the leveling connection rack, and an adapter protrusion is formed on the adapter plate.

In a preferred solution of the stubble burying, puddling, and land leveling combined operation machine according to the present disclosure, the traction component includes a traction cylinder arranged on the base rack and the traction ropes extending outward from the traction cylinder, and the traction ropes are connected to the leveling plate.

Through-holes matching with the traction ropes are provided in the leveling connection rack.

In a preferred solution of the stubble burying, puddling, and land leveling combined operation machine according to the present disclosure, the stopper includes a slot formed on the joint block and a retaining block slidably connected in the slot, the retaining block is provided with a first inclined surface and the adapter protrusion is provided with a second inclined surface matching with the first inclined surface, an elastic member is provided between the retaining block and the slot, a counterweight component is arranged between the leveling connection rack and the support rack, and the counterweight component includes a plurality of counterweight blocks slidably connected to the adapter plate; when the adapter plate and the rear connector are engaged, the first inclined surface matches with the second inclined surface, enabling the counterweight blocks to shift between the adapter plate and the joint block.

In a preferred solution of the stubble burying, puddling, and land leveling combined operation machine according to the present disclosure, the counterweight component further includes a counterweight holder arranged on the leveling connection rack and an auxiliary block slidably connected in the counterweight holder, a slide bar is slidably connected to the auxiliary block, a cavity is formed in the auxiliary block, a transmission rod is rotatably connected in the cavity, and a stop block is rotatably connected in the cavity.

The stop block includes a lower end body hinged to the transmission rod and an upper end body connected to the lower end body, a torsion spring is arranged on a rotating shaft of the stop block and configured for driving the upper end body to cooperate with the counterweight blocks, the cavity is in outward communication with the auxiliary block, and the upper end body extends out of the auxiliary block. When the stop block moves to a position relative to the rear connector, the slide bar is configured for driving the upper end body to separate from the counterweight blocks.

In a preferred solution of the stubble burying, puddling, and land leveling combined operation machine according to the present disclosure, a joint plate is provided at a front end of the leveling connection rack, and a first cylinder connected to the auxiliary block is arranged on the leveling connection rack.

The present disclosure further discloses an operation method of the stubble burying, puddling, and land leveling combined operation machine, which includes:
unfolding the auxiliary racks and the leveling connection racks;
releasing the operation machine to enter a working state, where
the working state includes a turning state;
performing adaptive adjustment based on soil conditions through positional relationships between the counterweight blocks and the leveling plate in practical land leveling;
using a map comparison method to identify working ground during operation.

In a preferred solution of the operation method of the stubble burying, puddling, and land leveling combined operation machine according to the present disclosure, as for the turning state:
the traction cylinders retract to pull back the traction ropes and the leveling plate is lifted; the operation machine is released after a turning is made.

In a preferred solution of the operation method of the stubble burying, puddling, and land leveling combined operation machine according to the present disclosure, the counterweight blocks are adjusted during operation in the following steps:
determining a number of the counterweight blocks to be moved according to need;
controlling the first cylinder to push the auxiliary block forward;
pulling the auxiliary block upward to make the slide bar contact the joint plate, where the slide bar, limited by the joint plate, slides into the cavity and drives the transmission rod to rotate accordingly, forcing the stop block to rotate out of the cavity and to be engaged with a side wall of the counterweight block for subsequent operation;
continuously pulling the auxiliary block in a reverse direction to draw the counterweight blocks away from the leveling plate, and redistributing weight on the leveling plate.

In a preferred solution of the operation method of the stubble burying, puddling, and land leveling combined operation machine according to the present disclosure, the map comparison method for scanning and identification includes the following steps:
scanning an unleveled region P0 and a leveled region Q0 by lidar at a time point T0 to obtain relative point cloud maps of the unleveled region P0 and the leveled region Q0, an origin of the relative point cloud map being at a geometric center of the lidar;
recording absolute coordinates of current locations by a global navigation satellite system (GNSS), and converting the relative point cloud maps of the unleveled region P0 and the leveled region Q0 into absolute point cloud maps through relative positions of the lidar and a main antenna of a GNSS receiver;
using the above method again at a time point T1 to obtain absolute point cloud maps of an unleveled region P1 and a leveled region Q1;
setting a reasonable sampling interval to make the unleveled region P1 and the unleveled region P0 have an overlapping area and the leveled region Q1 and the leveled region Q0 have an overlapping area; and using a point cloud registration algorithm to splice the absolute maps of the unleveled region P1 and the unleveled region P0 and splice the absolute maps of the leveled region Q1 and the leveled region Q0;
continuously splicing the maps in a cycle during the operation to obtain maps of unleveled regions and leveled regions of a larger area;
interpolating the point cloud map of the unleveled region in front and calculating an unevenness a₁ of the region; and calculating an unevenness a₂ after leveling according to the absolute coordinates, where a leveling effect δ is calculated by:

δ=a₁−a₂.

The present disclosure has the following beneficial effects: During working, an operator unfolds the auxiliary racks through the flippers and uses a tractor to lower the entire operation machine, making the leveling component contact the ground. Then, the operation machine is pulled by the tractor to move and carry out combined operations of stubble burying, puddling, and land leveling. Therefore, the problem that feedback-based adjustment of an existing land leveler lags behind is solved, and the width of an existing machine is increased through the foldable auxiliary racks. Meanwhile, an intelligent detection technology (using front radars to detect the effect before leveling and rear radars to detect the effect after leveling) is employed to collect soil elevation data before and after leveling as well as collect and analyze data of the relationship between the counterweight of the land leveler and the soil quality, thereby obtaining optimal working parameters.

When the number of the counterweight blocks needed is determined, the first cylinder is controlled to push the auxiliary block forward. Then, the auxiliary block is pulled upward to make the slide bar contact the joint plate. The slide bar, limited by the joint plate, slides into the cavity and drives the transmission rod to rotate accordingly. The rotation of the transmission rod pulls the lower end body to rotate in a direction away from the surface of the cavity, and thus the upper end body rotates out of the cavity. After that, the auxiliary block is continuously pulled till the upper end body abuts against the lower end of the counterweight block. When the auxiliary block is pulled back, the counterweight blocks are drawn in a direction away from the leveling plate, and the weight on the leveling plate is redistributed.

The contact state between the leveling plate and the ground can be adjusted through the counterweight blocks, and the contact area and contact strength between the leveling plate and the ground can be adjusted accordingly. Real-time adjustment can be made according to different ground conditions. The adjustment structure is simple and easy to operate. The operator can choose different numbers of the counterweight blocks or different weights of the counterweight blocks for accurate control of counterweight.

### BRIEF DESCRIPTION OF THE DRAWINGS

To illustrate the technical solutions in the embodiments of the present disclosure more clearly, the accompanying drawings required for the description of the embodiments are introduced briefly in the following. Apparently, the accompanying drawings in the following description show merely some embodiments of the present disclosure, and persons of ordinary skill in the art can derive other drawings from the accompanying drawings without creative efforts.

FIG. 1 is a rear view of the overall structure of a stubble burying, puddling, and land leveling combined operation machine according to the present disclosure.

FIG. 2 is a front view of the overall structure of the stubble burying, puddling, and land leveling combined operation machine according to the present disclosure.

FIG. 3 is a top view of the overall structure of the stubble burying, puddling, and land leveling combined operation machine according to the present disclosure.

FIG. 4 is a structural view of a stopper in the stubble burying, puddling, and land leveling combined operation machine according to the present disclosure.

FIG. 5 is an enlarged view of a traction component in the stubble burying, puddling, and land leveling combined operation machine according to the present disclosure.

FIG. 6 is a cross-sectional view of the internal structure of an auxiliary block in the stubble burying, puddling, and land leveling combined operation machine according to the present disclosure.

List of Reference Numerals: 100. main assembly; 101. base rack; 102. auxiliary rack; 103. flipper; 103a. driving cylinder; 103b. first pull rod; 103c. second pull rod; 103d. support rod; 104. rear connector; 200. leveling component; 201. leveling plate; 300. operation assembly; 301. stubble-burying component; 301a. stubble-burying rod; 301b. star wheel harrow; 302. puddling component; 302a. straight roller; 104a. leveling connection rack; 104b. support rack; 105. hinge; 105a. extension rod rack; 202. joint block; 203. stopper; 203a. slot; 203b. retaining block; 204. adapter plate; 205. adapter protrusion; 206. first inclined surface; 207. second inclined surface; 400. traction component; 401. traction cylinder; 402. traction rope; 500. counterweight component; 501. counterweight block; 502. counterweight holder; 503. auxiliary block; 504. slide bar; 505. cavity; 506. transmission rod; 507. stop block; 507a. lower end body; 507b. upper end body; 507c. torsion spring; 508. joint plate; 509. first cylinder.

### DETAILED DESCRIPTION OF THE EMBODIMENTS

In order to make the objectives, features, and advantages of the present disclosure more obvious and understandable, the specific implementations of the present disclosure are described in detail below with reference to the accompanying drawings.

Specific details are set forth in the following description to facilitate a full understanding of the present disclosure, but the present disclosure can also be implemented in other ways different from those described herein, and persons skilled in the art can make similar extensions without departing from the essence of the present disclosure. Therefore, the present disclosure is not limited to the specific embodiments disclosed below.

The term “one embodiment” or “embodiments” used herein refers to specific features, structures, or characteristics that can be incorporated in at least one implementation of the present disclosure. The term “in one embodiment” that appears at different places in this specification does not necessarily refer to the same embodiment, nor does it refer to an embodiment mutually exclusive of other embodiments individually or selectively.

The present disclosure is described in detail with reference to the schematic diagrams. For the sake of convenience in describing the embodiments of the present disclosure in detail, the cross-sectional diagrams of device structures will not be partially enlarged at a general scale, and the schematic diagrams are only exemplary, instead of limiting the protection scope of the present disclosure. In addition, dimensions including length, width, and depth should be covered in actual production.

### Embodiment

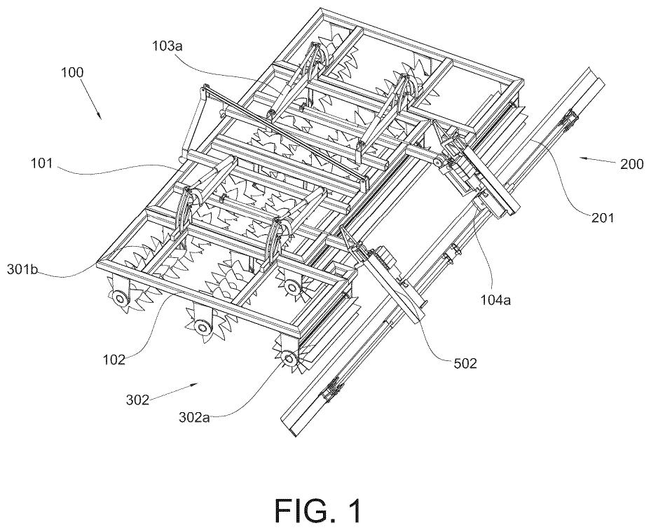

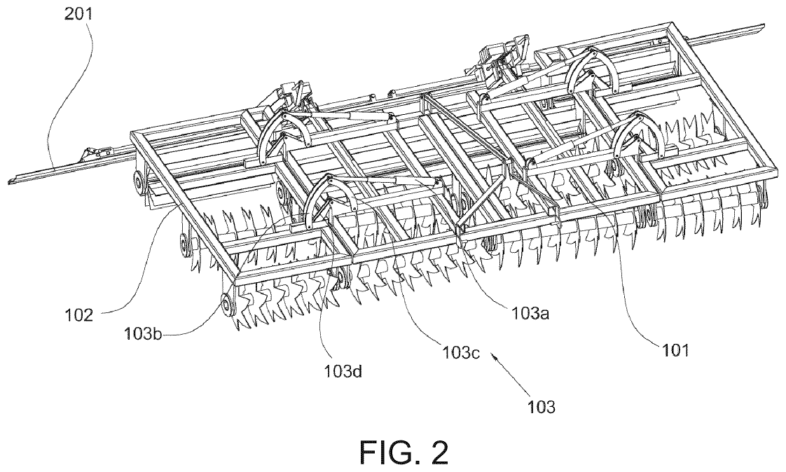

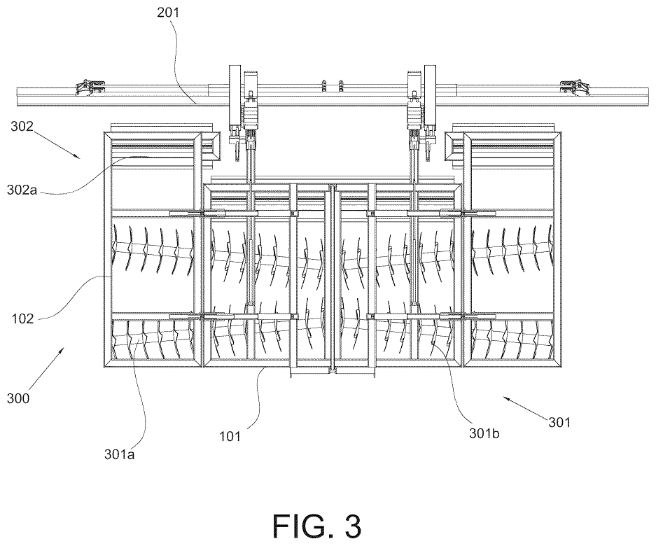

Referring to FIG. 1 to FIG. 3, the present disclosure discloses a stubble burying, puddling, and land leveling combined operation machine, which includes a main assembly 100. The main assembly 100 includes a base rack 101. The base rack 101 is made of hard alloy and is frame-shaped. The base rack 101 includes an external frame with a plurality of hard alloy connecting bars, and the alloy connecting bars are fixed to the external frame by welding.

Further, auxiliary racks 102 are arranged on two ends of the base rack 101 and are hinged to the base rack 101 through mechanisms. The auxiliary racks 102 are flipped upward after being rotated and are folded for later transportation.

Four flippers 103 are arranged between the base rack 101 and the auxiliary racks 102, and the flippers 103 are symmetrically arranged in pairs. The flipper 103 includes a driving cylinder 103a arranged on the base rack 101 and a first pull rod 103b and a second pull rod 103c both hinged to the driving cylinder 103a. A lower end of the first pull rod 103b is hinged to the auxiliary rack 102, a lower end of the second pull rod 103c is hinged to the base rack 101, and upper ends of the first pull rod 103b and the second pull rod 103c are both hinged to a cylinder shaft of the driving cylinder 103a. A support rod 103d is fixed on the auxiliary rack 102 at a position near the hinge point of the first pull rod 103b. An upper end of the support rod 103d is inclined toward the base rack 101 and is hinged to the base rack 101. When the cylinders retract, the auxiliary rack is flipped upward to be folded through the traction of the first pull rods 103b and the support rods 103d.

Further, rear connectors 104 are arranged at a back end of the base rack 101, and a leveling component 200 is arranged on the rear connectors 104. In this embodiment, the rear connectors 104 extend horizontally and are connected to the leveling component, and the leveling component mainly includes a leveling plate for soil leveling after previous operation.

Further, the present disclosure includes an operation assembly 300. In this embodiment, the operation assembly 300 includes a puddling component 302 and a stubble-burying component 301 both arranged on the base rack 101.

In this embodiment, the stubble-burying component 301 includes a plurality of stubble-burying rods 301a arranged at a lower end of the base rack 101 and star wheel harrows 301b arranged on the stubble-burying rods 301a. When the base rack 101 is pulled forward, the star wheel harrows 301b rotate synchronously on the soil to perform a stubble burying operation.

Preferably, four stubble-burying rods 301a are provided and are symmetrically arranged in pairs in an inclined manner. When viewed from above the base rack 101, the right ends of the two stubble-burying rods 301a on the left side are close to each other, and the left ends of the two stubble-burying rods 301a on the right side are close to each other, thereby forming an inclined state. This arrangement allows a certain angle to be formed between the rotation plane of the star wheel harrows 301b and the vertical plane, making it easier to bury stubble and turn over the soil.

Further, in this embodiment, the puddling component 302 includes straight rollers 302a arranged at the back ends of the base rack 101 and the auxiliary racks 102. The straight rollers 302a are transversely arranged with lower ends flush with the lower ends of the star wheel harrows 301b.

Operation process: An operator unfolds the auxiliary racks 102 through the flippers 103 and uses a tractor to lower the entire operation machine, making the leveling component contact the ground. Then, the operation machine is pulled by the tractor to move and carry out combined operations of stubble burying, puddling, and land leveling. Therefore, the problem that feedback-based adjustment of an existing land leveler lags behind is solved, and the width of an existing machine is increased through the foldable auxiliary racks 102. Meanwhile, an intelligent detection technology (using front radars to detect the effect before leveling and rear radars to detect the effect after leveling) is employed to collect soil elevation data before and after leveling as well as collect and analyze data of the relationship between the counterweight of the land leveler and the soil quality.

### Embodiment

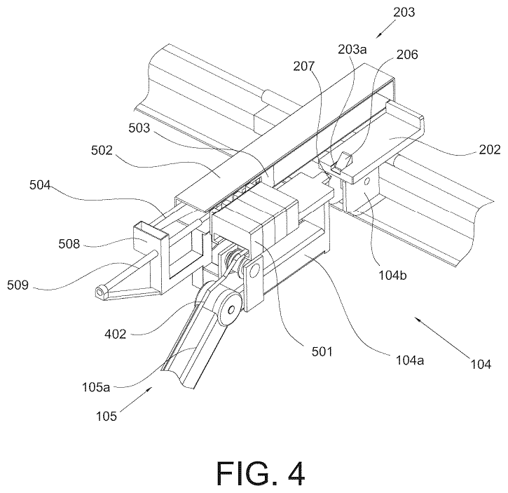

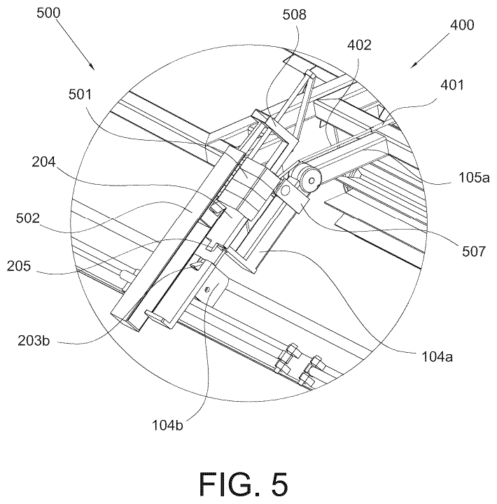

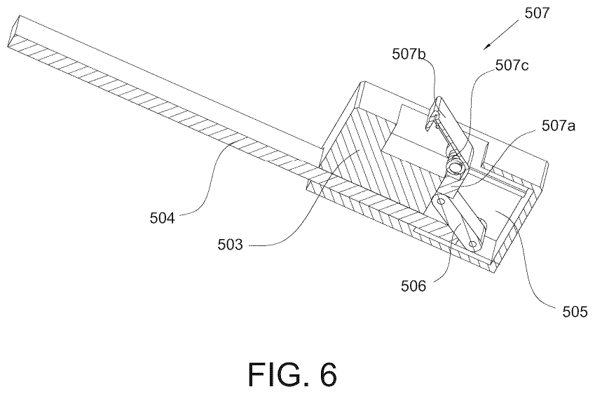

Referring to FIG. 4 to FIG. 6, this embodiment is different from the previous embodiment in the following aspects. In this embodiment, the rear connector includes a leveling connection rack 104a arranged at the back end of the base rack 101. The leveling connection rack 104a made of a relatively hard material plays a supporting role and extends toward the back end of the base rack 101. A support rack 104b is also provided on the leveling connection rack 104a to assist the leveling connection rack 104a in supporting. A hinge 105 is arranged between the leveling connection rack and the base rack 101.

In this embodiment, the hinge 105 includes an extension rod rack 105a arranged at the back end of the base rack 101, a circular hole plate is arranged at an end of the extension rod rack 105a, an ear plate matching with the circular hole plate is arranged on the leveling connection rack 104a, and the ear plate and the circular hole plate are hinged by a hinge shaft.

Further, in this embodiment, the leveling component 200 includes a leveling plate 201 arranged at back ends of the leveling connection racks 104a, and the leveling plate 201 is configured for land leveling. Joint blocks 202 are also provided on the leveling plate 201 and are arranged corresponding to the two extension rod racks 105a. A stopper 203 is arranged on the joint block 202. A traction component 400 is arranged between the leveling plate 201 and the leveling connection rack 104a. An adapter plate 204 matching with the stopper 203 is provided on the leveling connection rack 104a, and the adapter plate 204 is arranged corresponding to an upper surface of the joint block 202. An adapter protrusion 205 is formed on the adapter plate 204 and extends outward to be engaged with the stopper 203.

Further, in this embodiment, the traction component 400 includes a traction cylinder 401 arranged on the base rack 101. The traction cylinder 401 extends linearly along the extension rod rack 105a, and traction ropes 402 extend outward from the traction cylinder 401. The traction cylinder 401 retracts and extends to control the forward and backward movement of the traction ropes 402. The leveling plate 201 is connected to the traction ropes 402, and the traction cylinder 401 can control the state of the leveling plate 201. To realize control of the leveling plate 201, through-holes matching with the traction ropes 402 are provided in the leveling connection rack 104a, so that the traction ropes 402 will not shift or drop when being pulled and the overall rigidity of the traction ropes 402 during the pulling process is increased.

Further, in this embodiment, the stopper 203 includes a slot 203a formed on the joint block 202 and a retaining block 203b slidably connected in the slot 203a. The slot 203a is provided on the upper surface of the joint block 202 and opens upward. The retaining block 203b is slidably connected to the slot 203a, and an elastic member is provided between the retaining block 203b and the slot 203a. The elastic member is a spring and the spring keeps pushing the retaining block 203b out of the slot 203a in a natural state. The retaining block 203b is provided with a first inclined surface 206 facing the base rack 101, and the adapter protrusion 205 is provided with a second inclined surface 207 matching with the first inclined surface 206. When the traction ropes 402 pull the leveling plate 201, the joint block 202 approaches the adapter plate 204, and the adapter protrusion 205 is pressed against the retaining block 203b. Since the second inclined surface 207 faces downward, the first inclined surface 206 and the second inclined surface 207 cooperate to push the retaining block 203b into the slot 203a. A counterweight component 500 is arranged between the leveling connection rack 104a and the support rack 104b. After the pushing, the counterweight component 500 changes position to balance the weight of the leveling plate 201.

In this embodiment, the counterweight component 500 includes a plurality of counterweight blocks 501 slidably connected to the adapter plate 204, a counterweight holder 502 arranged on the leveling connection rack 104a, and an auxiliary block 503 slidably connected in the counterweight holder 502. The counterweight holder 502 is disposed at a side of the adapter plate 204 and has a U-shaped cross section with the opening facing the adapter plate 204. The lower ends of the counterweight blocks 501 extend from the lower edge of the adapter plate 204 and bend toward the center of the adapter plate 204, so that the counterweight blocks 501 will not detach from the adapter plate 204 and can slide along the length of the adapter plate 204.

Further, a slide bar 504 is slidably connected to the auxiliary block 503, a cavity 505 is formed in the auxiliary block 503, the slide bar 504 extends from the auxiliary block 503, a transmission rod 506 is rotatably connected in the cavity 505 and one end of the transmission rod 506 is hinged to the slide bar 504, and a stop block 507 is rotatably connected in the cavity 505. In an initial state, one end of the slide bar 504 extends into the cavity 505 and is close to the surface of the cavity 505, the transmission rod 506 is in an inclined state, and an upper end of the stop block 507 extends out of the cavity 505.

Preferably, the stop block 507 includes a lower end body 507a hinged to the transmission rod 506 and an upper end body 507b connected to the lower end body 507a, a torsion spring 507c is arranged on a rotating shaft of the stop block 507, the cavity 505 is in outward communication with the auxiliary block 503, and the upper end body 507b extends out of the auxiliary block 503 to pull the counterweight block 501, thereby adjusting the position of the counterweight block 501. A joint plate 508 is provided at a front end of the leveling connection rack 104a, and a first cylinder 509 connected to the auxiliary block 503 is arranged on the leveling connection rack 104a.

Operation process: When the number of the counterweight blocks 501 needed is determined, the first cylinder 509 is controlled to push the auxiliary block 503 forward. Then, the auxiliary block 503 is pulled upward to make the slide bar 504 contact the joint plate 508. The slide bar 504, limited by the joint plate 508, slides into the cavity 505 and drives the transmission rod 506 to rotate accordingly. The rotation of the transmission rod 506 pulls the lower end body 507a to rotate in a direction away from the surface of the cavity 505, and thus the upper end body 507b rotates out of the cavity 505. After that, the auxiliary block 503 is continuously pulled till the upper end body 507b abuts against the lower end of the counterweight block 501. When the auxiliary block 503 is pulled back, the counterweight blocks 501 are drawn in a direction away from the leveling plate 201 and the weight on the leveling plate 201 is redistributed.

The contact state between the leveling plate 201 and the ground can be adjusted through the counterweight blocks 501, and the contact area and contact strength between the leveling plate 201 and the ground can be adjusted accordingly. Real-time adjustment can be made according to different ground conditions. The adjustment structure is simple and easy to operate. The operator can choose different numbers of the counterweight blocks 501 or different weights of the counterweight blocks 501 for accurate control of counterweight.

### Embodiment

Different from the previous embodiment, this embodiment discloses an operation method of the stubble burying, puddling, and land leveling combined operation machine. The method includes the following steps:

The auxiliary racks 102 and the leveling connection racks 104a are unfolded.

The operation machine is released and enters a working state.

The working state includes a turning state.

In the turning state of this embodiment, the traction cylinders 401 retract to pull back the traction ropes 402, the leveling connection racks 104a are pulled upward, and the leveling plate 201 is lifted from the ground to reduce the obstruction against the ground. A tractor hydraulic device is used to raise the operation machine or not, depending on the specific situation. Then, a turning is made and the operation machine is released afterwards.

The following operation is performed before the operation machine is transported:

Firstly, the auxiliary racks 102 are reversely driven and drawn back.

The two ends of the leveling plate 201 are folded by hydraulic cylinders, and then the operation machine is lifted by the tractor hydraulic device to complete transportation preparation.

Further, adaptive adjustment is performed based on soil conditions through positional relationships between the counterweight blocks 501 and the leveling plate 201 in practical land leveling.

During the working process, a map comparison method is configured for scanning and identification. In this embodiment, the map comparison method for scanning and identification includes the following steps:

An unleveled region P0 and a leveled region Q0 are scanned by lidar at a time point T0 to obtain relative point cloud maps of the unleveled region P0 and the leveled region Q0. The origin of the relative point cloud map is at the geometric center of the lidar.

Absolute coordinates of current locations are recorded by GNSS, and the relative point cloud maps of the unleveled region P0 and the leveled region Q0 are converted into absolute point cloud maps through relative positions of the lidar and a main antenna of a GNSS receiver.

The above method is used again at a time point T1 to obtain absolute point cloud maps of an unleveled region P1 and a leveled region Q1.

A reasonable sampling interval is set. In this embodiment, the sampling interval is 5 to 10 min, making the unleveled region P1 and the unleveled region P0 have an overlapping area and the leveled region Q1 and the leveled region Q0 have an overlapping area. A point cloud registration algorithm is used to splice the absolute maps of the unleveled region P1 and the unleveled region P0 and splice the absolute maps of the leveled region Q1 and the leveled region Q0.

The maps are continuously spliced in a cycle during the operation to obtain maps of unleveled regions and leveled regions of a larger area.

The point cloud map of the unleveled region in front is interpolated and the unevenness a₁ of the region is calculated. After leveling, the unevenness a₂ is calculated according to the absolute coordinates, where the leveling effect δ is calculated by:

δ=a₁−a₂ (1).

Statistics are made on the calculation results to obtain a map of more leveled regions for subsequent observations and work arrangements.

It should be appreciated that numerous implementation-specific decisions can be made in the development of any actual implementation, as in engineering or design projects. Such a development effort might be complex and time-consuming, but would nevertheless be a routine undertaking of design, fabrication, and manufacture for persons of ordinary skill having the benefit of this disclosure without undue experimentation.

It should be noted that the above embodiments are merely used for illustrating instead of limiting the technical solutions of the present disclosure. Although the present disclosure has been described in detail with reference to the preferred embodiments, persons of ordinary skill in the art should understand that modifications or equivalent replacements can still be made to the technical solutions of the present disclosure without departing from the spirit and scope of the present disclosure, and all the modifications or equivalent replacements shall fall within the protection scope of the appended claims of the present disclosure.

What is claimed is:

1. A stubble burying, puddling, and land leveling combined operation machine, comprising a main assembly, wherein the main assembly comprises a base rack, auxiliary racks arranged on the base rack, and rear connectors arranged at a back end of the base rack; a leveling component is arranged on the rear connectors; and
the rear connector comprises a leveling connection rack arranged at the back end of the base rack and a support rack arranged on the leveling connection rack, the leveling connection rack is connected to the base rack via at least two traction ropes, the traction ropes are configured for driving the leveling component to move forward and backward relative to the base rack, and when the traction ropes retract to a position relative to the base rack, the leveling component is in a suspended state above ground;
the leveling component comprises a leveling plate arranged at back ends of the leveling connection racks, joint blocks arranged on the leveling plate, and stoppers respectively arranged on the joint blocks; a traction component is arranged between the leveling plate and the leveling connection rack,
an adapter plate matching with the stopper is arranged on the leveling connection rack, and an adapter protrusion is formed on the adapter plate;
the traction component comprises a traction cylinder arranged on the base rack and the traction ropes extending outward from the traction cylinder, the traction ropes are connected to the leveling plate, and
through-holes matching with the traction ropes are provided in the leveling connection rack;
the stopper comprises a slot formed on the joint block and a retaining block slidably connected in the slot, the retaining block is provided with a first inclined surface and the adapter protrusion is provided with a second inclined surface matching with the first inclined surface, an elastic member is provided between the retaining block and the slot, a counterweight component is arranged between the leveling connection rack and the support rack, and the counterweight component comprises a plurality of counterweight blocks slidably connected to the adapter plate; when the adapter plate and the rear connector are engaged, the first inclined surface matches with the second inclined surface, enabling the counterweight blocks to shift between the adapter plate and the joint block.

2. The stubble burying, puddling, and land leveling combined operation machine according to claim 1, wherein the counterweight component further comprises a counterweight holder arranged on the leveling connection rack and an auxiliary block slidably connected in the counterweight holder, a slide bar is slidably connected to the auxiliary block, a cavity is formed in the auxiliary block, a transmission rod is rotatably connected in the cavity, and a stop block is rotatably connected in the cavity;
the stop block comprises a lower end body hinged to the transmission rod and an upper end body connected to the lower end body, a torsion spring is arranged on a rotating shaft of the stop block and configured for driving the upper end body to cooperate with the counterweight blocks, the cavity is in outward communication with the auxiliary block, and the upper end body extends out of the auxiliary block; when the stop block moves to a position relative to the rear connector, the slide bar is configured for driving the upper end body to separate from the counterweight blocks.

3. The stubble burying, puddling, and land leveling combined operation machine according to claim 2, wherein a joint plate is provided at a front end of the leveling connection rack, and a first cylinder connected to the auxiliary block is arranged on the leveling connection rack.

4. An operation method of the stubble burying, puddling, and land leveling combined operation machine according to claim 3, comprising:
unfolding the auxiliary racks and the leveling connection racks;
releasing the stubble burying, puddling, and land leveling combined operation machine to enter a working state, wherein
the working state comprises a turning state;
performing adaptive adjustment based on soil conditions through positional relationships between the counterweight blocks and the leveling plate in practical land leveling; and
using a map comparison method to identify working ground during operation.

5. The operation method of the stubble burying, puddling, and land leveling combined operation machine according to claim 4, wherein in the turning state:
the traction cylinders retract to pull back the traction ropes and the leveling plate is lifted; and
the stubble burying, puddling, and land leveling combined operation machine is released after a turning is made.

6. The operation method of the stubble burying, puddling, and land leveling combined operation machine according to claim 5, wherein the counterweight blocks are adjusted during the operation in the following steps:
determining a number of the counterweight blocks to be moved according to need;
controlling the first cylinder to push the auxiliary block forward;
pulling the auxiliary block upward to make the slide bar contact the joint plate, wherein the slide bar, limited by the joint plate, slides into the cavity and drives the transmission rod to rotate accordingly, forcing the stop block to rotate out of the cavity and to be engaged with a side wall of the counterweight block for subsequent operation; and
continuously pulling the auxiliary block in a reverse direction to draw the counterweight blocks away from the leveling plate, and redistributing weight on the leveling plate.

7. The operation method of the stubble burying, puddling, and land leveling combined operation machine according to claim 4, wherein the map comparison method for scanning and identification comprises the following steps:
scanning a first unleveled region (P0) and a first leveled region (Q0) by light detection and ranging (LiDAR) at a first time point (T0) to obtain relative point cloud maps of the first unleveled region (P0) and the first leveled region (Q0), an origin of the relative point cloud map being at a geometric center of the LiDAR;
recording absolute coordinates of current locations by a global navigation satellite system (GNSS), and converting the relative point cloud maps of the first unleveled region (P0) and the first leveled region (Q0) into absolute point cloud maps through relative positions of the LiDAR and a main antenna of a GNSS receiver;
using the above method again at a second time point (T1) to obtain absolute point cloud maps of a second unleveled region (P1) and a second leveled region (Q1);
setting a sampling interval to make the second unleveled region (P1) and the first unleveled region (P0) have an overlapping area and the second leveled region (Q1) and the first leveled region (Q0) have an overlapping area; and using a point cloud registration algorithm to splice the absolute maps of the second unleveled region (P1) and the first unleveled region (P0) and splice the absolute maps of the second leveled region (Q1) and the first leveled region (Q0);
continuously splicing the maps in a cycle during the operation to obtain maps of unleveled regions and leveled regions of a larger area; and
interpolating the point cloud map of the unleveled region in front and calculating an unevenness a₁ of the region; and calculating an unevenness a₂ after leveling according to the absolute coordinates, wherein a leveling effect δ is calculated by:
δ=a₁−a₂.
